(19) United States
(12) Patent Application Publication
(10) Pub. No.: US 2015/0239562 A1
(43) Pub. Date: Aug. 27, 2015

(54) MONITOR DEVICE

(71) Applicant: Panasonic Intellectual Property Management Co., Ltd., Osaka (JP)

(72) Inventor: Yoshihiko Nakano, Osaka (JP)

(21) Appl. No.: 14/431,760

(22) PCT Filed: Mar. 8, 2013
(86) PCT No.: PCT/JP2013/001545

§ 371 Date: Mar. 26, 2015

(30) Foreign Application Priority Data
Nov. 6, 2012 (JP) 2012-244618

(51) Int. Cl. B64D 11/00; F16M 13/02

(52) U.S. Cl. CPC B64D 11/0015; F16M 13/027; F16M 13/022

(57) ABSTRACT

To provide a monitor device of which a monitor having at least a certain width can be attached under conditions in which the width of the attachment portion is limited, a monitor device is one that rotatably supports a monitor, said monitor device comprising a support component, a rotation component, and a rotation selector. The support component supports the monitor. The rotation component allows the monitor to rotate with respect to the support component. The rotation selector allows the monitor to rotate only when the monitor device is not in a powered state.

### PRIORITY

This is a National Stage Application under 35 U.S.C. §365 of International Application PCT/JP2013/001545, with an international filing date of Mar. 8, 2013, which claims priority to Japanese Patent Application No. 2012-244618 filed on Nov. 6, 2012. The entire disclosures of International Application PCT/JP2013/001545 and Japanese Patent Application No. 2012-244618 are hereby incorporated herein by reference.

### TECHNICAL FIELD

The present disclosure relates to a monitor device having an opening and closing type of monitor installed on the ceiling portion of the cabin of a passenger aircraft or the like.

### BACKGROUND ART

In recent years, monitor devices for providing passengers with service to display video, and the like have been installed in the cabins of airplanes, trains, buses, passenger ships, and other such modes of transportation. These monitor devices are often configured so that they can be opened and closed (see Patent Literature 1, for example).

In particular, with a passenger aircraft, monitor devices are attached to the bottom part of the overhead bins above the passenger seats.

The monitor devices installed in aircraft and so forth are limited in their width to the available attachment space of the ceiling portion of the cabin. Therefore, as conventional monitor, liquid crystal panels and the like that were suited to width limitations are used.

### CITATION LIST

### Patent Literature

Patent Literature 1: Japanese Laid-Open Patent Application H10-149107

### SUMMARY

### Technical Problem

However, the following problem was encountered with the above-mentioned conventional configuration. Specifically, when only a monitor having a width that fits the limited width of the attachment portion can be used as in the past, it can be difficult to accommodate the larger screens that are popular today.

The present disclosure provides a monitor device of which a monitor having a width that is equal to or greater than the width of the attachment portion can be attached under conditions in which the width of the attachment portion has limited width.

### Solution to Problem

The monitor holding device pertaining to the present disclosure is a monitor device that rotatably supports a monitor, and comprises a support component, a rotation component, and a rotation selector. The support component supports the monitor. The rotation component allows the monitor to rotate with respect to the support component. The rotation selector allows the monitor to rotate only when the monitor device is not in a powered state.

### Advantageous Effects

With the monitor device pertaining to the present disclosure, a monitor having a width that is equal to or greater than the width of the attachment portion can be attached under conditions in which the attachment portion has limited width.

### BRIEF DESCRIPTION OF DRAWINGS

FIG. 1a is an oblique view of a state in which the monitor device pertaining to Embodiment 1 of the present disclosure has been installed on the ceiling of the cabin of an aircraft, and the monitor is closed, and FIG. 1b is an oblique view of the state when this monitor is open;

FIG. 2 is a front view of the monitor device pertaining to Embodiment 1 of the present disclosure;

FIG. 3 is a side view of the monitor device pertaining to Embodiment 1 of the present disclosure;

FIG. 4 is an oblique view of the monitor device pertaining to Embodiment 1 of the present disclosure, as seen from below;

FIG. 5 is a simplified diagram of the monitor device pertaining to Embodiment 1 of the present disclosure, as seen from the front;

FIG. 6 is a simplified partial cross section of the monitor device pertaining to Embodiment 1 of the present disclosure, as seen from the front;

FIG. 7a is an oblique view of the area near a switch of the monitor device pertaining to Embodiment 1 of the present disclosure, and FIG. 1b is a simplified side view of the area near the switch of the monitor device pertaining to Embodiment 1 of the present disclosure;

FIG. 8 is an oblique view of a state in which the monitor of the monitor device pertaining to Embodiment 1 of the present disclosure has been rotated, as seen from below;

FIG. 9 is a simplified front cross section of the area near the attachment portion to which is attached the monitor device pertaining to Embodiment 1 of the present disclosure;

FIG. 10a is a front view illustrating the operation when a monitor device is attached to a ceiling, and FIG. 10b is an oblique view illustrating the operation when a monitor device is attached to a ceiling, as seen from above;

FIG. 11 is a simplified partial cross section of the monitor device pertaining to Embodiment 1 of the present disclosure, as seen from the front;

FIG. 12 is a simplified partial cross section of the monitor device pertaining to Embodiment 1 of the present disclosure, as seen from the front;

FIG. 13 is a front view illustrating the operation when the monitor device pertaining to Embodiment 1 of the present disclosure is attached to a ceiling;

FIG. 14 is a front view of a state in which the monitor has been rotated when the monitor device is attached to a ceiling; and

FIG. 15 is a partial simplified diagram of a modification example of the monitor device pertaining to Embodiment 1 of the present disclosure.

### DETAILED DESCRIPTION

Embodiments pertaining to this disclosure will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art. The applicant has provided the appended drawings and the following description so that a person skilled in the art might fully understand this disclosure, but does not intend for these to limit subject matters described in claims.

### Embodiment 1

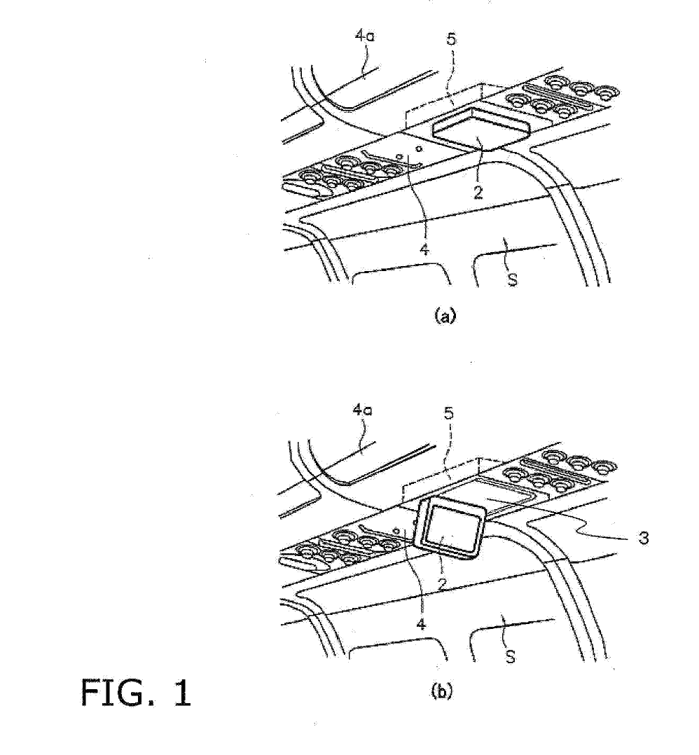

The monitor device pertaining to an embodiment of the present disclosure will now be described through reference to FIGS. 1 to 14.

### 1. Configuration

### 1-1. Summary of Monitor Device 1

As shown in FIGS. 1a and 1b, the monitor device 1 pertaining to this embodiment is provided to the ceiling 4 of a cabin S of a passenger aircraft, and more particularly under an opening and closing package shelf 4a installed on the ceiling 4. The monitor device 1 in Embodiment 1 is attached to the ceiling 4 by disposing a support component 3 (discussed below) that supports a monitor 2, on an attachment component 5 formed on the ceiling 4.

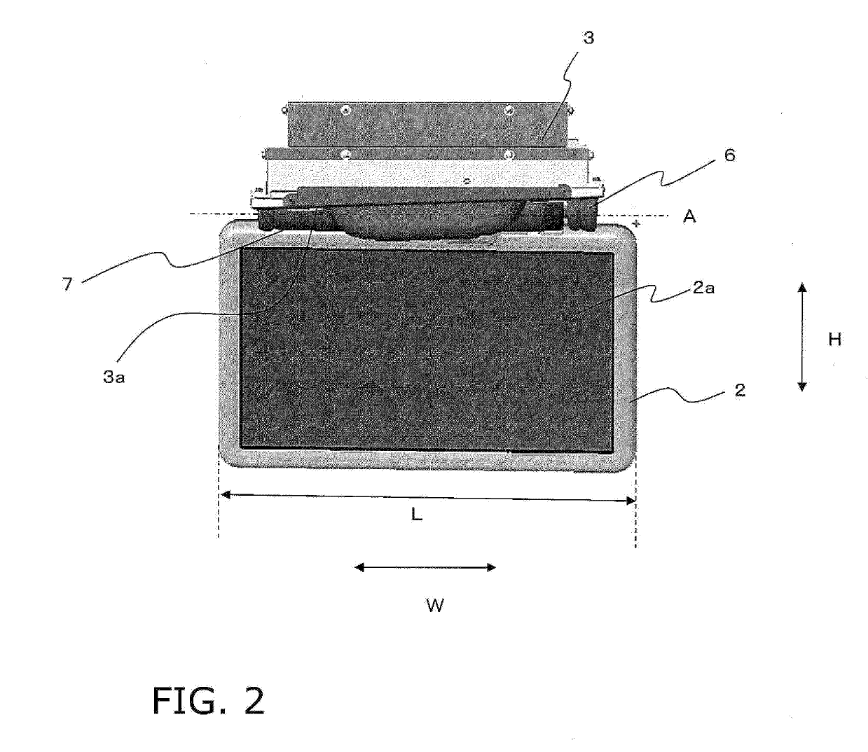

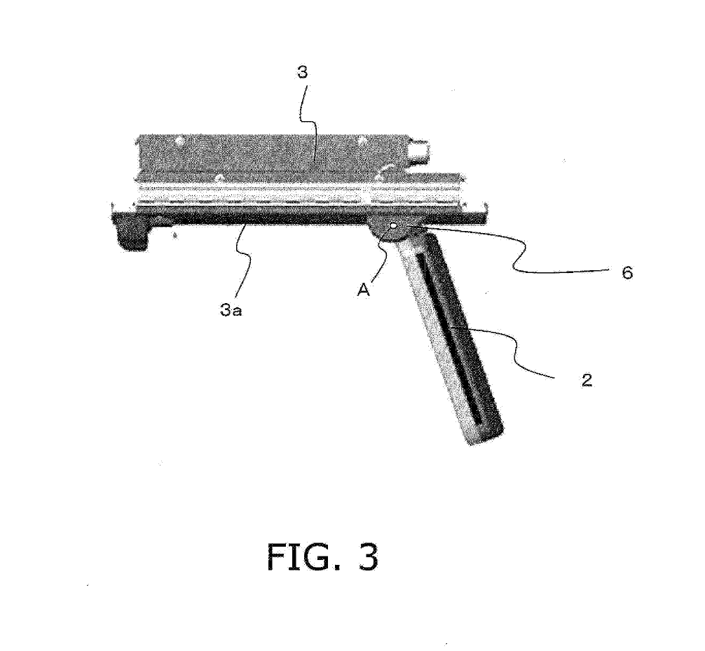

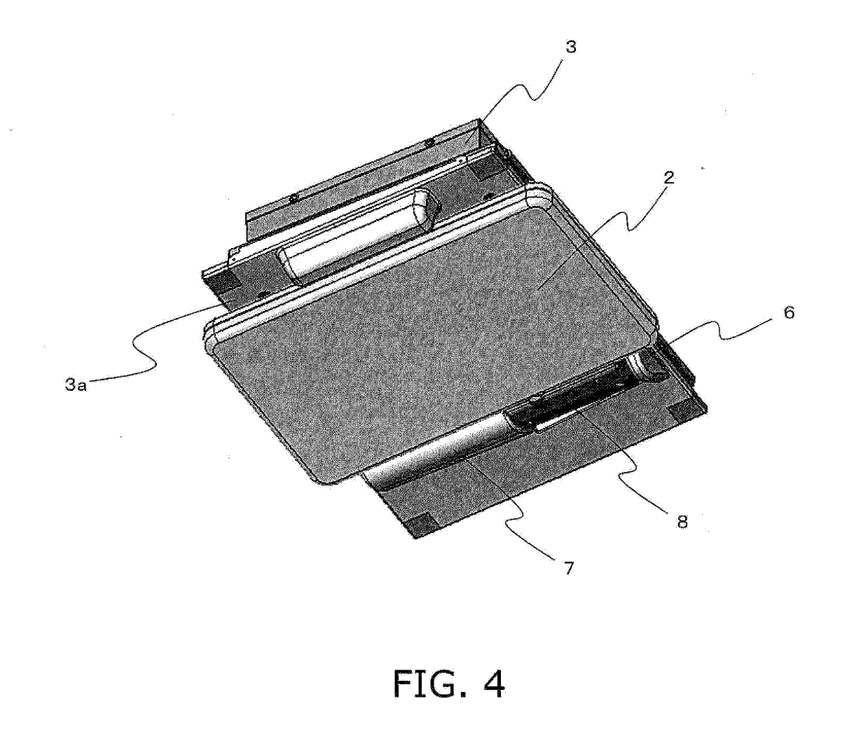

FIG. 2 is a front view of the monitor device 1 in Embodiment 1. FIG. 3 is a side view of the monitor device 1 in Embodiment 1. FIG. 4 is an oblique view of the state when the monitor 2 of the monitor device 1 in Embodiment 1 is closed, as seen from underneath.

As shown in FIGS. 2 and 3, the monitor device 1 has the monitor 2, the support component 3 that supports the monitor 2, cylindrical components 6 and 7 provided to the support component 3, and an opening and closing component 8 provided to the monitor 2.

The monitor device 1 rotates around a rotational axis A (see FIGS. 2 and 3) formed near the upper end in an open state (usage state), and thereby transitions from a stowed state (closed state) in which it is parallel to the surface 3a of the support component 3, to a usage state (open state) in which it has been opened by about 110 degrees with respect to the plane of the support component 3, as shown in FIGS. 2 to 4.

As shown in FIG. 2, the monitor 2 has a substantially square shape in front view.

The monitor 2 has a display screen 2a, and this display screen 2a is an LCD (liquid crystal display) or other such display panel that is provided to display video and so forth toward a passenger in an open state.

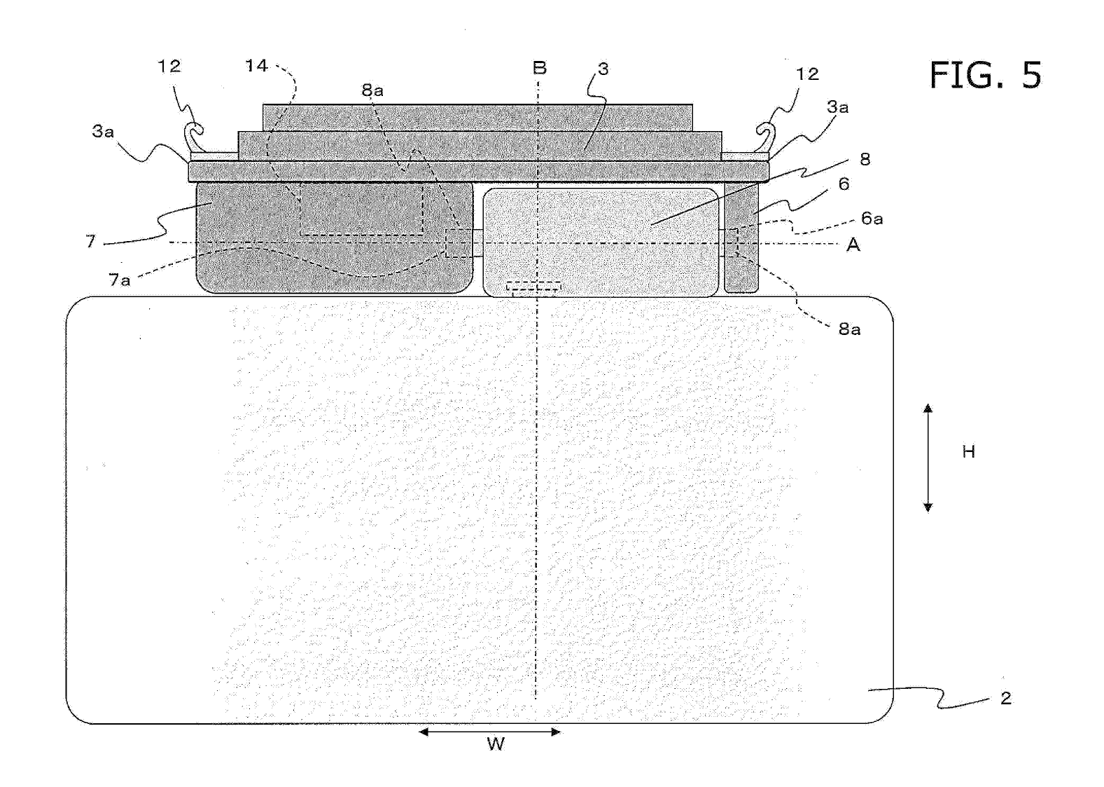

FIG. 5 is a simplified diagram of the monitor device in Embodiment 1 as seen from the front. As shown in FIG. 5, the cylindrical component 6 is provided on one side (the right side in the drawing) out of the two ends along the rotational axis A of the support component 3. The cylindrical component 7 has a substantially cylindrical shape and is longer than the cylindrical component 6, and is provided toward the other side (the left side in the drawing) out of the two ends along the rotational axis A of the support component 3. The opening and closing component 8 is linked to the monitor 2 and is disposed in between the cylindrical component 6 and the cylindrical component 7. A shaft 8a that sticks out to the left and right sides from the opening and closing component 8 is disposed in holes 6a and 7a formed in the cylindrical components 6 and 7. With this configuration, the monitor 2 and the opening and closing component 8 rotate between open and closed states while axially supported by the cylindrical components 6 and 7.

Rotation of the monitor 2 between open and closed states is accomplished by transmitting the rotational drive force of a motor 14 disposed in the cylindrical component 7 to the shaft 8a.

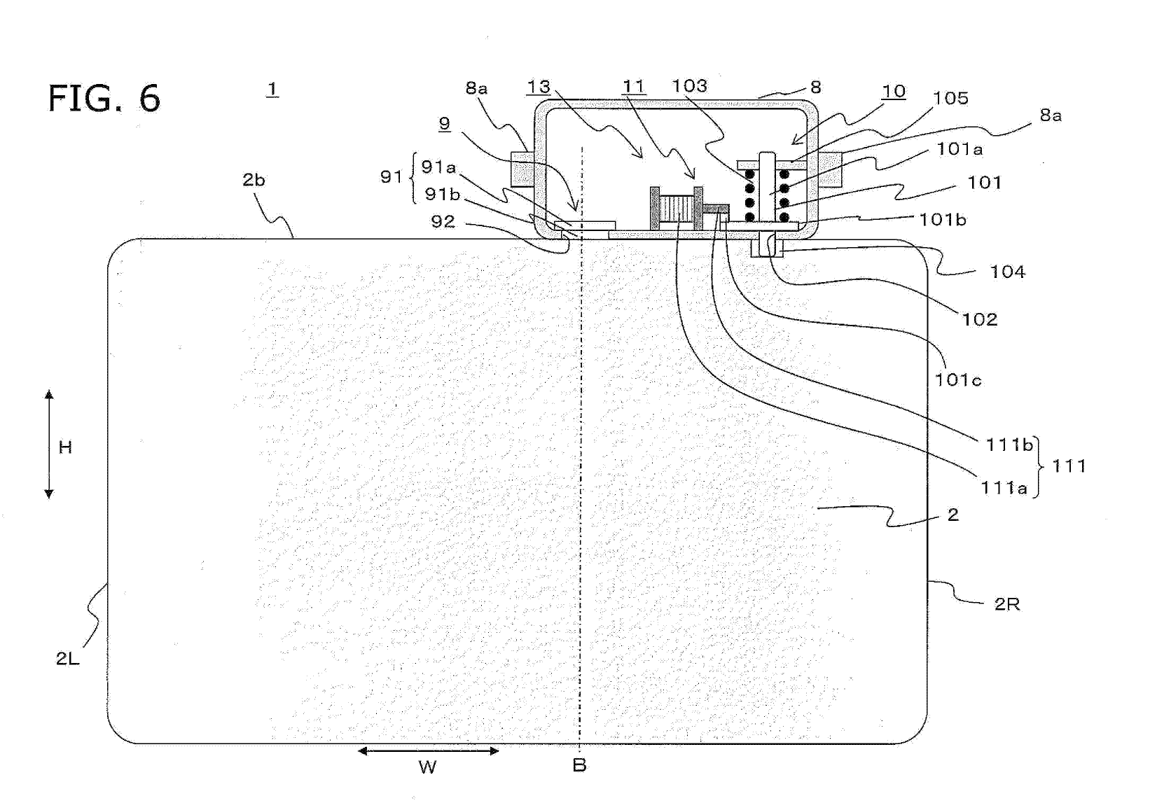

FIG. 6 is a simplified partial diagram of the monitor device in Embodiment 1, and in particular shows the internal configuration of the opening and closing component 8.

The above-mentioned opening and closing component 8 is a hollow member, the inside of which is provided with a rotation component 9 that allows the monitor 2 to rotate, and a rotation selector 13 that makes rotation by the rotation component 9 possible. This rotation selector 13 has a fixing component 10 that locks and restricts the rotation of the monitor 2, and a release component 11 that allows restriction by the fixing component 10 to be released.

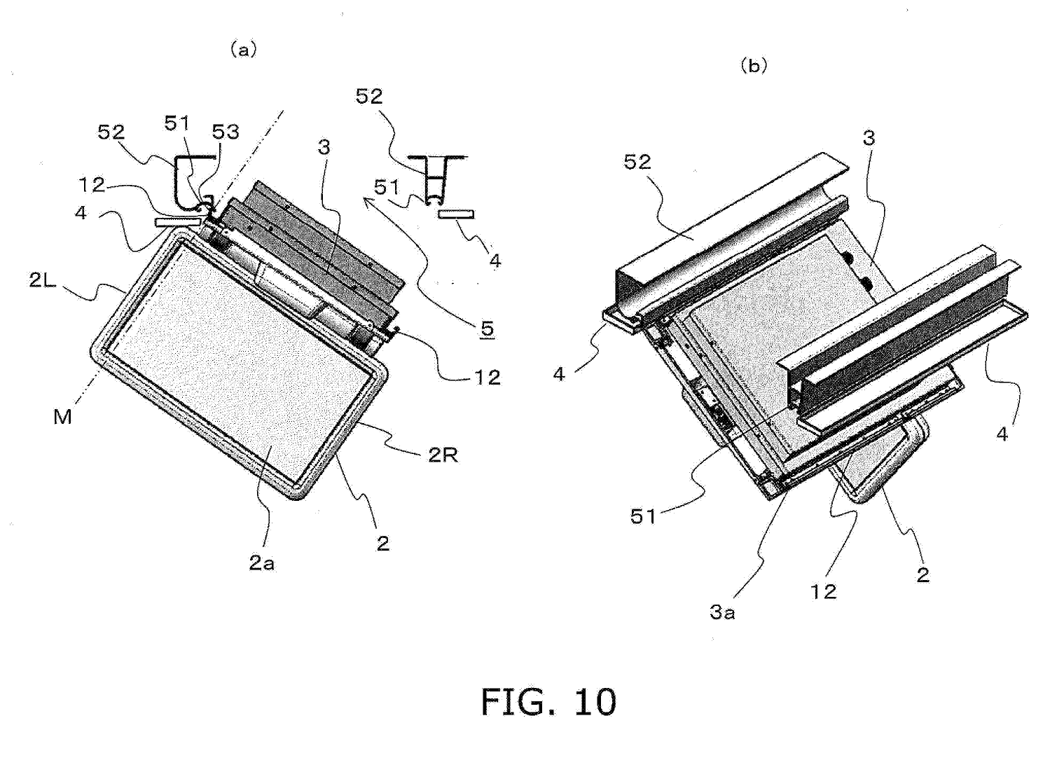

As shown in FIG. 5, latching components 12 for attaching the monitor device 1 to the attachment component 5 of the ceiling 4 are provided to both ends 3a in the width direction (see the arrow W in the drawing) on the ceiling side of the support component 3. As shown in FIG. 10b (discussed below), these latching components 12 are formed along the ends 3a.

The various components will now be described in further detail.

### 1-2. Rotation Component 9

As shown in FIG. 6, the rotation component 9 has a rotation support component 91 provided to the monitor 2.

The rotation support component 91 is formed so as to protrude upward from the edge (top edge 2b) on the ceiling 4 side of the monitor 2 when the monitor 2 is open. This rotation support component 91 has a disk-shaped member 91a that is disposed on the inside of the opening and closing component 8, and a column-shaped member 91b that is smaller in diameter than the disk-shaped member 91a and connects the disk-shaped member 91a and the monitor 2.

A circular first opening 92 is formed in the surface of the opening and closing component 8, and this first opening 92 is smaller in diameter than the disk-shaped member 91a. The column-shaped member 91b passes through this first opening 92.

Since the disk-shaped member 91a is thus larger in diameter than the first opening 92, when the monitor 2 is open, the disk-shaped member 91a is in contact with the inner walls of the opening and closing component 8. Accordingly, the monitor 2 is supported by the opening and closing component 8 and is able to rotate around the column-shaped member 91b without falling off. The center axis B of the column-shaped member 91b is an example of a rotational axis that is parallel to the height direction of the monitor 2 (see the arrow H in the drawing).

### 1-3. Fixing Component 10

As shown in FIG. 6, the fixing component 10 has a pin 101, a second opening 102 formed in the surface of the opening and closing component 8, a spring member 103, and a support member 105 that slidably supports the pin 101. A recess 104 is formed in a portion of the top edge 2b of the monitor 2 (the edge on the opening and closing component 8 side) in an open state.

The pin 101 has a pin main body 101a and a pressing component 101b that is pressed by the spring member 103 attached around the pin main body 101a. This pressing component 101b is fixed to the pin main body 101a. The pin main body 101a is able to protrude from the second opening 102 formed in the surface of the opening and closing component 8, toward the recess 104 of the monitor 2. The pin main body 101a is slidably supported by the support member 105 formed on the inner walls of the opening and closing component 8. The spring member 103 is fixed at one end to the support member 105, and the other end of the spring member 103 is fixed to the pressing component 101b. This pressing component 101b is disposed on the inside of the opening and closing component 8. Thus, the pin 101 is biased by the spring member 103 in the direction of protruding from the opening and closing component 8.

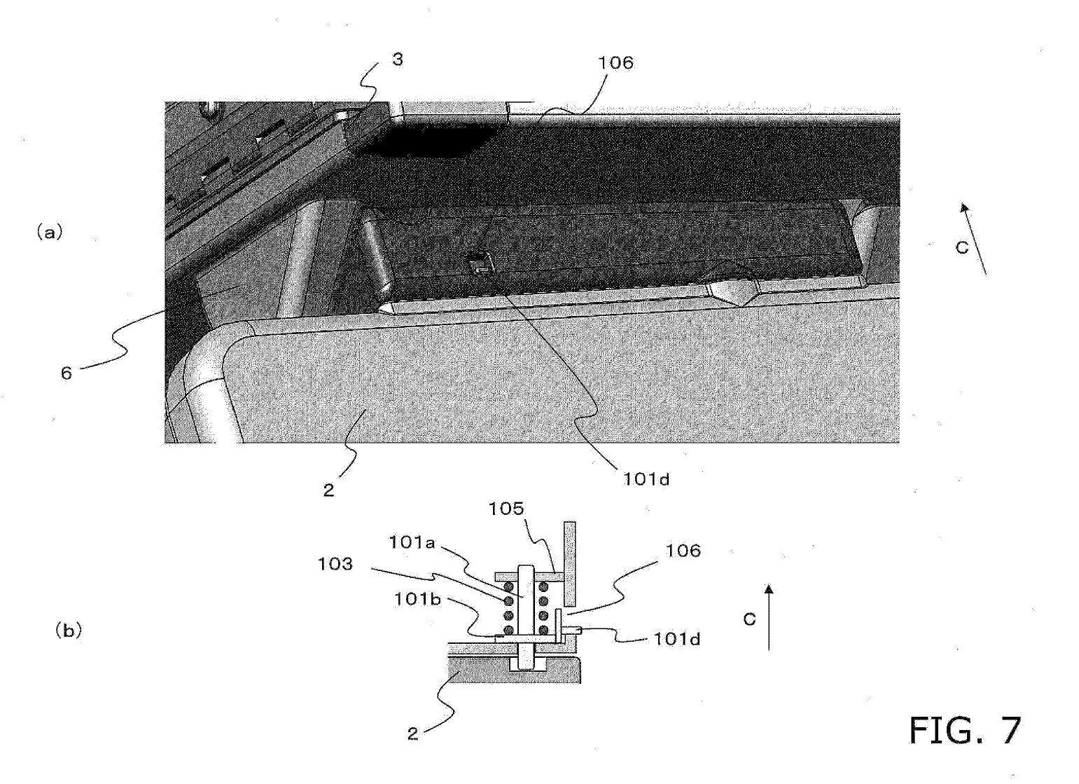

A switch 101d is provided to the pin 101 so as to be exposed on the outside of the opening and closing component 8. FIG. 7a is a view of the area near the switch 101d when the monitor 2 is open, as seen from the rear face side. FIG. 7b is a simplified side view of the area near the switch 101d when the monitor 2 is open.

As shown in FIGS. 7a and 7b, a third opening 106 is formed in the surface of the opening and closing component 8, and the switch 101d is exposed from this third opening 106. When the switch 101d is moved upward, it moves above the pin main body 101a that is linked to the switch 101d, and the distal end of the pin main body 101a is pulled out from the recess 104.

Specifically, in a state in which the distal end of the pin main body 101a is inserted into the recess 104, even if the user attempts to rotate the monitor 2 around the column-shaped member 91b, this rotation will be restricted because the pin main body 101a interferes with the inner wall of the recess 104.

### 1-4. Release Component 11

The release component 11 will now be described. As shown in FIG. 6, the release component 11 has a solenoid 111 provided in the interior of the opening and closing component 8. This solenoid 111 is made up of a coil 111a and a core 111b, and is a push-type solenoid with a built-in return spring. Specifically, in an unpowered state, the elastic force of the return spring pulls the core 111b inside the coil 111a, and the core 111b is pushed out when power is supplied.

When the monitor device 1 is in a powered state, the electromagnetic force of the coil 111a causes the core 111b to move so that its distal end portion is disposed on the upper side of an interference component 101c formed on the pressing component 101b of the pin 101. In a state in which the core 111b is thus located on the upper side of the interference component 101c, even if the switch 101d is moved to the upper side and an attempt is made to pull the pin main body 101a out of the recess 104, the interference component 101c will interfere with the core 111b and prevent the pin main body 101a from being pulled out of the recess 104. Therefore, this prevents the restriction of the rotation of the monitor 2 from being released.

When the solenoid 111 of the release component 11 is not powered, the core 111b is moved by a return spring (not shown) to the coil 111a side, and separates from the interference component 101c.

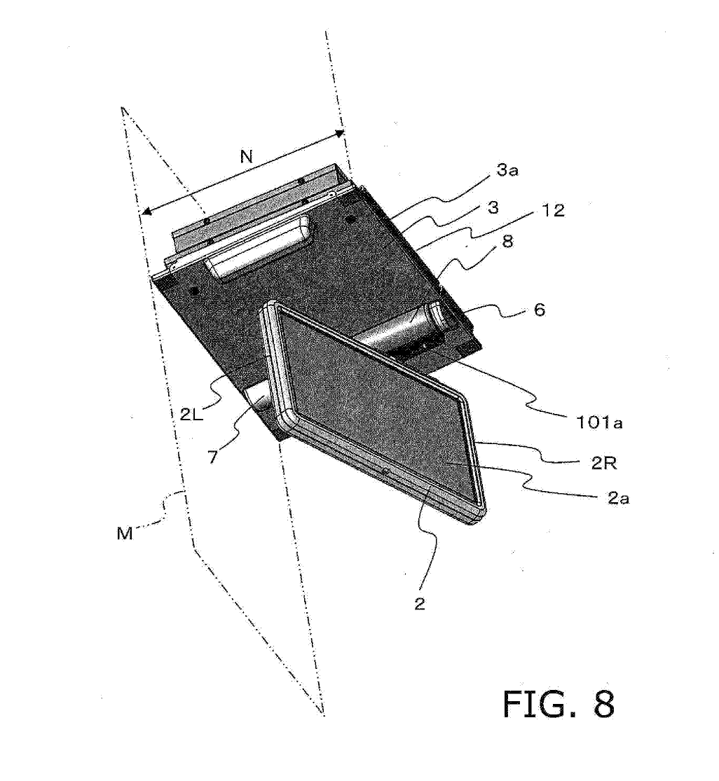

Thus, in a state in which the core 111b has moved away from the interference component 101c, the switch 101d (see FIGS. 7a and 7b) is moved upward (the arrow C direction), and the pin main body 101a is pulled out of the recess 104, which allows the monitor 2 to rotate around the column-shaped member 91b. FIG. 8 shows the state when the monitor 2 is being rotated. Thus, the monitor device 1 in this embodiment is configured so that the monitor 2 can be rotated with respect to the support component 3.

The rotation mechanism of the monitor 2 is used by a worker when the monitor device 1 is installed at the attachment component 5 formed on the ceiling 4 of the cabin S of an aircraft, or during repair or replacement such as when the monitor device 1 has malfunctioned, and is not used by passengers or other people who use the aircraft.

Next, the configuration of the attachment component 5 and the latching components 12 provided to the monitor device 1 in order to attach the monitor device 1 to the attachment component 5 will be described.

### 1-5. Attachment Configuration of Monitor Device 1

As shown in FIGS. 5 and 10b (discussed below), the monitor device 1 in Embodiment 1 is provided with the latching components 12 along each end 3a at the both ends 3a in the width direction on the ceiling 4 side of the support component 3. Because the latching components 12 are thus provided at both ends in the width direction of the support component 3, the width of the support component 3 is substantially the same as the spacing between the two latching components 12 (see N in FIG. 8).

These latching components 12 are formed so that they stick out toward the ceiling 4 side, and are formed in the shape of a hook, in which the distal end is bent inward in width W direction.

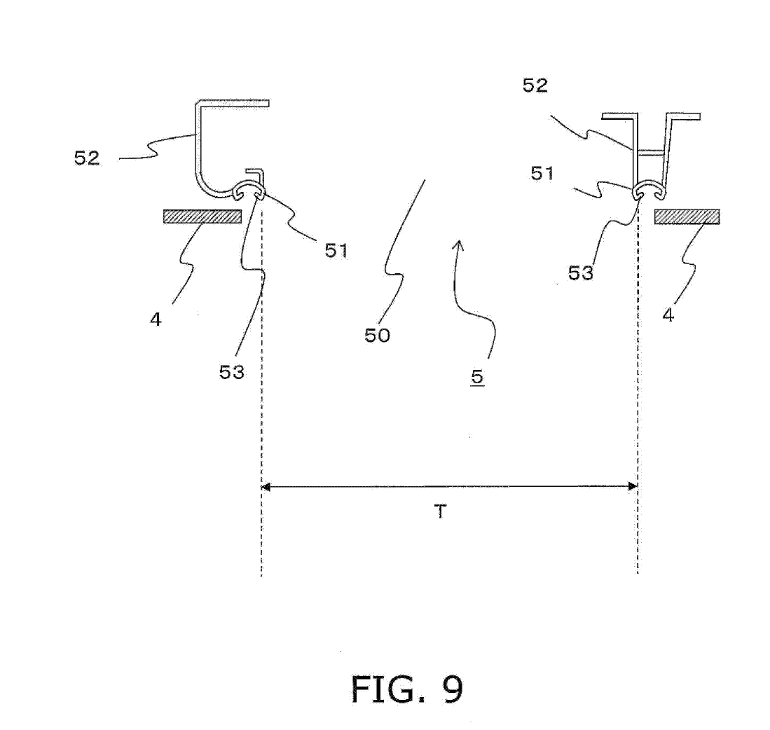

FIG. 9, meanwhile, is a simplified diagram of the configuration of the attachment component 5. As shown in FIG. 9, the attachment component 5 has a stowage space 50 in which the support component 3 is stowed, and rails 51 that are provided at the left and right ends in the width direction of the stowage space 50, and to which the latching components 12 of the monitor device 1 are latched. These rails 51 are substantially semicircular in shape, bending upward in a bump shape when viewed in cross section, and the end portions thereof are formed in a hook shape that curves back toward the inside. Of the hook-shaped portions of these ends, the portions of the hook shape disposed on the stowage space 50 side serve as support components 53 that are latched by the latching components 12 of the monitor device 1. The rails 51 are provided to frames 52 provided on the upper side of the ceiling 4.

### 2. Attachment of Monitor Device 1

Next, the job of attaching the monitor device 1 in Embodiment 1 to the attachment component 5 of the ceiling 4 will be described.

When the monitor device 1 is attached to the ceiling 4, one of the latching components 12 of the monitor device 1 is hooked onto a support component 53 of a rail 51 on the ceiling 4. However, since the width L of the monitor 2 (see FIG. 2) is greater than the spacing T of the rails 51 (see FIG. 9), if the monitor 2 does not rotate with respect to the support component 3, the monitor 2 will come into contact with the ceiling 4 as shown in FIGS. 10a and 10b, which can end up scratching the monitor 2 or the ceiling 4.

In view of this, with the monitor device 1 in Embodiment 1, contact between the monitor 2 and the ceiling 4 is avoided by rotating the monitor 2 with respect to the support component 3 and it is possible to attach the monitor device 1 to the attachment component 5 of the ceiling 4.

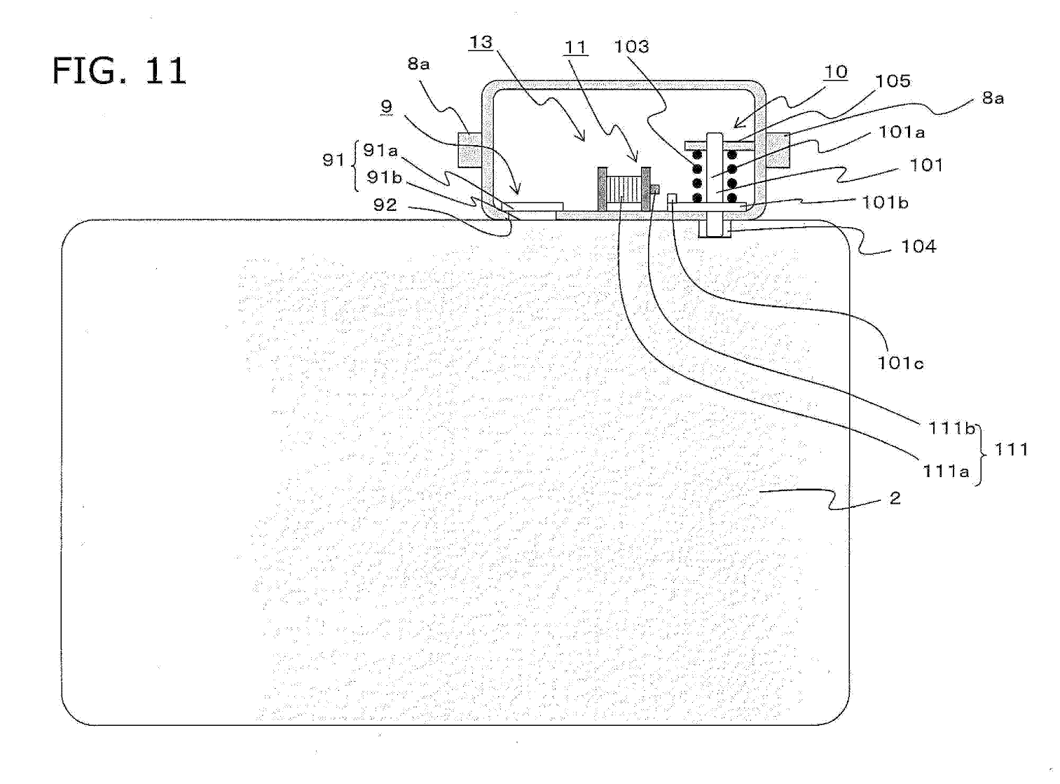

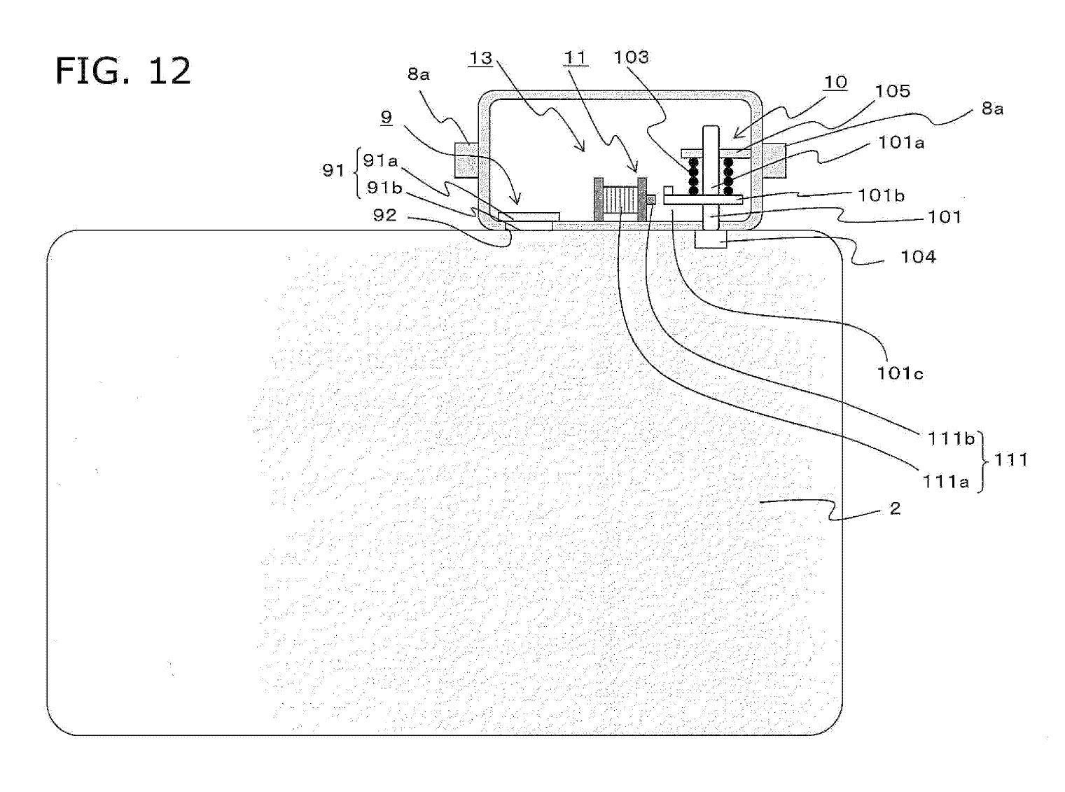

This will now be described in specific terms through reference to FIGS. 11 to 13. FIGS. 11 and 12 are simplified partial diagrams of the monitor device in Embodiment 1, and in particular show the internal configuration of the opening and closing component 8.

In attaching the monitor device 1 to the ceiling 4, the monitor device 1 is not connected to the wiring of the aircraft, and is not powered. Therefore, as shown in FIG. 11, the core 111b of the solenoid 111 is moved to the coil 11 1a by the return spring, and the core 111b moves away from the interference component 101c.

The worker then moves the switch 101d in the arrow C direction in FIGS. 7a and 7b. As shown in FIG. 12, this movement pulls the pin main body 101a out of the recess 104 of the monitor 2. In a state in which the pin main body 101a has been pulled out of the recess 104, as shown in FIG. 8, the monitor 2 is rotated around the column-shaped member 91b until the monitor 2 fits within the width N of the support component 3 (between the two latching components 12). More specifically, as shown in FIGS. 8 and 10, the monitor 2 is at least rotated up to a position at which the edge 2L in the width W direction of the monitor 2 is disposed in a plane M that is substantially perpendicular to the width direction of the two latching components 12, including the left latching component 12.

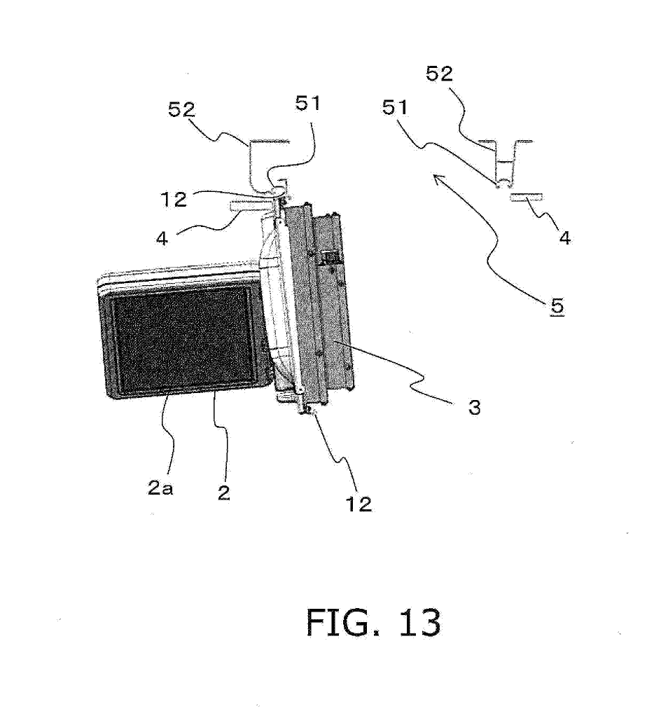

In a state in which the monitor 2 has thus been rotated to fit within the width N of the support component 3 (between the two latching components 12), when one of the latching components 12 of the monitor device 1 is hooked onto a support component 53 of a rail 51 on the ceiling 4, the monitor 2 does not hit the ceiling 4. Therefore, as shown in FIG. 13, one of the latching components 12 of the monitor device 1 (the left side in the drawing) can be hooked onto the support component 53 of one rail 51 (the left side in the drawing) of the attachment component 5 on the ceiling 4 without scratching the monitor 2 or the ceiling 4. After this, the monitor device 1 is connected to the wiring of the aircraft, and the other latching component 12 (the right side in the drawing) is hooked onto the support component 53 of the other rail 51 (the right side in the drawing). The switch 101d is then raised and the monitor is returned to its position prior to the rotation of the monitor 2 (the position where the top edge 2b of the monitor 2 is substantially perpendicular to the two rails), and when the user then removes his finger from the switch 101d, the spring member 103 moves the pin main body 101a downward, and the distal end of the pin main body 101a is inserted into the recess 104.

This is how the job of attaching the monitor device 1 is performed. Also, the rotation of the monitor 2 around the column-shaped member 91b is restricted by the insertion of the pin main body 101a into the recess 104.

With the above configuration, even when a monitor 2 that is wider than the width T of the attachment component 5 (see FIG. 9) is used for the monitor device 1, that monitor device 1 can still be attached to the attachment component 5.

### 3. Operation of Monitor Device 1 in Normal Usage

Next, the operation of the monitor device 1 during normal usage (such as when a passenger is on board) will described.

Before a flight, the captain turns on the aircraft electrical system, and power is also supplied to the monitor device 1. The passengers then board the aircraft, and the monitor 2 moves from its closed state to its open state under the drive force of the motor 14 (see FIG. 5), to provide onboard service. Video is then displayed on the display screen 2a of the monitor 2, and the passenger watches this video.

When the monitor device 1 is thus in a powered state, the solenoid 111 is also in a powered state. Therefore, the core 111b moves so that its distal end is disposed on the upper side of the interference component 101c of the pin 101. As a result of this movement, the pin main body 101a cannot be moved upward by operating the switch 101d.

Specifically, when the monitor device 1 is in a powered state, since the switch 101d cannot be moved upward (movement in the arrow C direction in FIGS. 7a and 7b), the monitor 2 cannot be rotated. In this embodiment, the powered state of the monitor device 1 refers to the period from when the captain turns on the aircraft electrical system until it is turned off, but is not limited to this.

As discussed above, if the rotation of the monitor 2 is restricted when the monitor device 1 is in a powered state, this prevents the passenger from operating the switch 101d and rotating the monitor 2. That is, because a wide monitor 2 is employed, a configuration is used in which it is possible to rotate the monitor 2 in the attachment of the monitor device 1, but when the monitor device 1 is in a powered state, its rotation can be locked so that a passenger is prevented from accidentally rotating the monitor 2.

### 4. Effect, etc.

4-1

As discussed above, in this embodiment, the monitor device 1 comprises the support component 3, the rotation component 9, and the rotation selector 13. The support component 3 supports the monitor 2. The rotation component 9 allows the monitor 2 to rotate with respect to the support component 3. The rotation selector 13 allows the monitor 2 to rotate only when the monitor device 1 is not in a powered state.

Consequently, in attaching the monitor device 1 (when the power is off), the rotation selector 13 keeps the monitor 2 from being rotated, so this avoids a situation in which the monitor 2 is rotate and comes into contact with the ceiling 4. Therefore, under conditions in which the width of the attachment component 5 is limited, a monitor 2 that is wider than the attachment component 5 can still be attached.

Also, since the monitor 2 cannot be rotated when the monitor device 1 is in an unpowered state, this prevents a passenger or the like from accidentally rotating the monitor 2.

4-2

Also, in this embodiment, the rotation selector 13 has the fixing component 10 and the release component 11. The fixing component 10 restricts the rotation of the monitor 2 by the rotation component 9, and fixes the monitor 2 in a specific position. The release component 11 allows the fixing by the fixing component 10 to be released +only when the monitor device 1 is not in a powered state. An example of the specific position where the monitor 2 is fixed is the position of the monitor 2 at which the top edge 2b is substantially perpendicular to the rails 51, as in this embodiment. The width W direction of the monitor 2 can also be considered a position that is substantially perpendicular to the rails 51. More specifically, an example of the specific position is the position of the monitor 2 shown in FIGS. 2 to 4, and the monitor 2 may be in either an open state or a closed state.

Consequently, in attaching the monitor device 1 (in an unpowered state), fixing by the fixing component 10 can be released, so the monitor 2 can be rotated. This means that a monitor 2 that is wider than the attachment component 5 can be attached under conditions in which the attachment component 5 has limited width.

Also, since the monitor 2 cannot rotate when the monitor device 1 is not in a powered state, a passenger is prevented from accidentally rotating the monitor 2.

4-3

Also, in this embodiment, the rotational axis B of the monitor 2 is parallel to the height direction H of the monitor 2. Consequently, the left edge 2L in the width direction W of the monitor 2 can be disposed at or to the inside of the latching components 12, so a monitor 2 that is wider than the attachment component 5 can be attached under conditions in which the attachment component 5 has limited width.

4-4

Also, in this embodiment, the monitor device 1 comprises the latching components 12 that are latched to at least two rails 51 disposed on the ceiling. The two latching components 12 are provided along the ends 3a in the width direction of the support component 3. The width of the monitor 2 is greater than the spacing between the two latching components 12 (see N in FIG. 8).

Consequently, even a monitor having a width that is greater than the spacing between the two latching components 12 (see N in FIG. 8) can be attached to the attachment component 5.

4-5

In this embodiment, the fixing component 10 has the pin 101 (an example of a fixing member). This pin 101 is provided movably between a fixed position in which the pin 101 restricts the rotation of the monitor 2 by interfering with this rotation, and fixes the monitor 2 in a specific position, and a non-fixed position in which the pin 101 does not interfere with the rotation of the monitor 2. The release component 11 has the solenoid 111. When the monitor device 1 is in a powered state, the solenoid 111 is also powered, the position of the core 111b of the solenoid 111 is fixed, and movement of the pin 101 from the fixed position to the non-fixed position is restricted by the core 111b. When the monitor device 1 is not in a powered state, the fixing of the position of the core 111b is released. An example of a fixed position corresponds to the position of the pin 101 in FIG. 6 (the position where the distal end of the pin main body 101a is inserted into the recess 104), and an example of a non-fixed position corresponds to the position of the pin 101 in FIG. 12 (the position where the distal end of the pin main body 101a has been pulled out of the recess 104). Also, an example of the position where the core 111b of the solenoid 111 is fixed in a powered state corresponds to the position of the core 111b in FIG. 6 (the position where the distal end of the core 111b is disposed on the upper side of the interference component 101c).

Consequently, when the monitor device 1 is in a powered state, movement of the pin 101 is restricted by the core 111b of the solenoid 111, and the passenger cannot move the switch 101d, so this prevents the passenger from accidentally rotating the monitor 2.

When the monitor device 1 is not in a powered state, the core 111b of the solenoid 111 is not fixed, so the distal end of the pin main body 101a can be pulled out of the recess 104 by moving the switch 101d, and the monitor 2 can be rotated. Accordingly, a monitor 2 that is wider than the attachment component 5 can be attached under conditions in which the attachment component 5 has limited width.

4-6

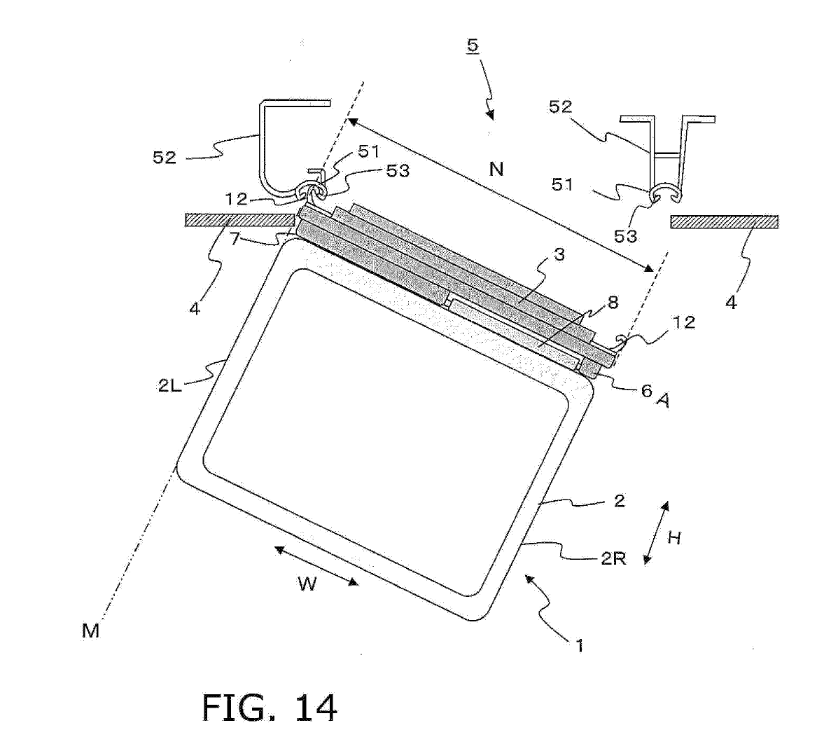

Also, in this embodiment, it is possible to rotate the monitor 2 at least from the specific position where the monitor 2 is fixed to the position where the end in the width direction of the monitor 2 (the left edge 2L or the right edge 2R) is disposed in the plane M including one of the two latching components 12 and perpendicular to the width direction of the two latching components 12 (see the arrow N in FIG. 8). FIG. 14 is a front view of the state when the monitor 2 has been rotated to a position where the edge 2L disposed in the width W direction of the monitor 2 is disposed in the plane M.

Consequently, when the latching components 12 are hooked onto the rails 51, the monitor 2 will be able to rotate to a position where it does not come into contact with the ceiling 4, so a monitor 2 that is wider than the attachment component 5 can be attached under conditions in which the attachment component 5 has limited width.

Furthermore, in this embodiment, the monitor 2 is configured to be able to rotate freely with respect to the opening and closing component 8, but even if the rotational angle of the monitor 2 is restricted by other parts or the like, as long as rotation up to the above-mentioned position is possible, the monitor device 1 can still be attached to the attachment component 5 of the ceiling 4.

### Other Embodiments

An embodiment of the present disclosure is described above, but the present disclosure is not limited to or by the above embodiment, and various modifications are possible without departing from the gist of the disclosure.

(A)

In the above embodiment, a solenoid is used as an example of a release component, but a solenoid is not the only option. For instance, the configuration may be such that the motor 14 that moves the monitor 2 from its closed state to its open state rotates a little more after the monitor 2 reaches to the open state, and this rotational force moves a member that restricts movement (in this embodiment, the core 111b) to a position where movement of the pin 101 is restricted (in this embodiment, the upper side of the interference component 101c).

(B)

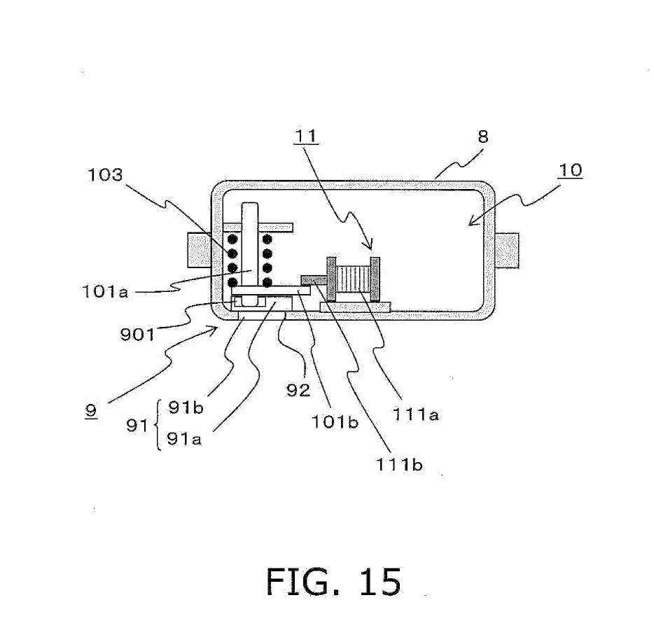

In the above embodiment, the pin 101, the spring member 103, etc., are used as fixing components, and the rotation of the monitor 2 is restricted by inserting the pin main body 101a of the pin 101 protruding from the opening and closing component 8 into the recess 104 formed in the monitor 2, but this configuration is not the only option. For instance, the configuration may be such that a recess 901 is formed in part of the upper face of the disk-shaped member 91a of the rotation support component 91, as shown in the interior of the opening and closing component in FIG. 15, and the pin main body 101a is inserted toward this recess 901. Since it is necessary to restrict the rotation of the monitor 2, the recess 901 into which the pin main body 101a is inserted needs to be provided at a location away from the center of the disk-shaped member 91a.

Also, a pin is not the only option for the fixing component, as long as the configuration restricts the rotation of the rotation support component 91, and the rotation of the monitor 2 may be restricted, for example, by pressing a brake pad or the like against the rotation support component 91.

(C)

In the above embodiment, it is said that the monitor device 1 is in a powered state from the time when the captain turns on the aircraft electrical system until it is turned off, and that the solenoid 111 is powered as long as the monitor device 1 is powered. Specifically, the monitor device 1 is always powered and the solenoid 111 is powered even when the monitor 2 is closed, but the flow of power to the monitor device 1 may be controlled to occur only when onboard service is being provided with the monitor device 1. In this case, since the monitor device 1 will be powered only from the start of the operation to switch the monitor device 1 from its closed state to its open state until the closed state is reached, the solenoid 111 is powered and the rotation of the monitor 2 is restricted only during this period.

(D)

In the above Embodiment 1, it is described that a return spring for pulling in the core 111b is provided to the solenoid 111, but the configuration may be such that no return spring is provided. For instance, in FIG. 6, when the monitor device 1 is rotated so that the core 111b is oriented vertically with respect to the ground (the right edge 2R of the monitor 2 is on top), the core 111b moves under its own weight to the coil 111a side, so the core 111b moves away from the upper side of the interference component 101c.

(E)

In the above embodiment, it is described that since at first the left latching component 12 is hooked onto a rail 51, the monitor 2 is rotated up to a position where at least the left edge 2L is in the plane M, but instead, first the right latching component 12 may be hooked onto the support component 53 of the right rail 51. Specifically, the right latching component 12 may be hooked onto the right rail 51 after the monitor 2 is at least rotated up to a position at which the right edge 2R is disposed in a plane that is substantially perpendicular to the width direction of the two latching components 12, including the right latching component 12.

(F)

In the above embodiment, the monitor 2 rotates at least up to the position where the edge 2L of the monitor 2 is disposed in the plane M, but this position may not be limited, and the monitor 2 should be able to rotate to a position where the monitor device 1 can be attached to the attachment component 5.

(G)

In the above embodiment, the description is of a monitor device 1 which a monitor 2 being substantially square in front view is used for, but the present disclosure is not limited to this. For example, in addition to substantially square, the shape of the monitor opened and closed by this monitor device may be polyhedral, circular, elliptical, or any of various other shapes, and the present disclosure can be applied to situations in which a monitor is so wide that it hits the ceiling and the monitor device cannot be attached.

Also, the monitor that is opened and closed need not be the LCD display panel discussed above, and may instead be some other kind of display panel.

(H)

In the above embodiment, a monitor device that is installed on the ceiling 4 of a passenger aircraft is described as an example, but the present disclosure is not limited to a monitor device mounted in the cabin of an aircraft. For example, it can be similarly applied to a monitor device that is installed in a train, a bus, a passenger ship, or any of various other means of transportation.

Also, the present disclosure is not limited to a monitor device that is installed in a means of transportation, and can be broadly applied as a monitor device that is installed on a ceiling surface.

Also, the installation location of the monitor device disclosed herein is not limited to the ceiling 4, and the monitor device can also be installed on the rear face of a front seat, for example. In other words, the present disclosure can be applied to situations involving the installation of a monitor device having a monitor that is wider than the attachment component.

Furthermore, the monitor device disclosed herein is configured so that it can be opened and closed because it is used in a passenger aircraft, etc., but if the monitor 2 does not need to be closed, then a mechanism for opening and closing it need not be provided.

### INDUSTRIAL APPLICABILITY

The effect of the monitor device disclosed herein is that a monitor that is wider than the attachment component can be attached under conditions in which the attachment component has limited width. Therefore, this monitor device can be applied broadly to stowage devices for monitors installed on ceilings.

1. A monitor device that rotatably supports a monitor, said monitor device comprising:
a support component that supports the monitor;
a rotation component that allows the monitor to rotate with respect to the support component; and
a rotation selector that allows the monitor to rotate only when the monitor device is not in a powered state.

2. The monitor device according to claim 1, wherein the rotation selector has:
a fixing component that restricts the rotation of the monitor by the rotation component and fixes the monitor in a specific position; and
a release component that allows the fixing by the fixing component to be released only when the monitor device is not in a powered state.

3. The monitor device according to claim 1, wherein a rotational axis of the monitor is parallel to a height direction of the monitor.

4. The monitor device according to claim 1, comprising latching components that are latched to at least two rails disposed on a ceiling,
wherein the two latching components are provided along two ends of the support component in a width direction, and
a width of the monitor is greater than a spacing between the two latching components.

5. The monitor device according to claim 2, wherein the fixing component has a fixing member that is able to move between a fixed position in which the fixing member restricts the rotation of the monitor by interfering with this rotation, and fixes the monitor in a specific position, and a non-fixed position in which the fixing member does not interfere with the rotation of the monitor,
the release component has a solenoid,
when the monitor device is in a powered state, a position of a core of the solenoid is fixed by a current flowing to the solenoid, and movement of the fixing member from the fixed position to the non-fixed position is restricted by the core, and
when the monitor device is not in a powered state, the fixing of the core position is released.

6. The monitor device according to claim 4, wherein the rotation component is able to rotate the monitor from a specific position where the rotation of the monitor is restricted, to a position where an end of the monitor in the width direction is disposed in a plane that is perpendicular to a width direction of the two latching components and includes one of the two latching components.
